(19) United States
(12) Patent Application Publication
(10) Pub. No.: US 2002/0067932 A1
(43) Pub. Date: Jun. 6, 2002

(54) Powder classifying device and image forming apparatus having the powder classifying device

(76) Inventors: Yuji Arai, Kawasaki-shi (JP); Satoshi Takano, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/996,752

(22) Filed: Nov. 30, 2001

(30) Foreign Application Priority Data
Nov. 30, 2000 (JP) 2000-365659
Nov. 16, 2001 (JP) 2001-352045

(51) Int. Cl. G03G 15/08; G03G 21/00

(52) U.S. Cl. 399/253; 399/359

(57) ABSTRACT

A powder classifying device that classifies powder includes a mesh member having meshes, and a brush roller formed with hair-like members and configured to rotate in sliding contact with the mesh member at a predetermined portion in a circumferential direction of the brush roller to push the powder conveyed in a radial direction of the brush roller against the meshes so that the powder is classified into powder passing through the meshes and powder not passing through the meshes.

### CROSS REFERENCES TO RELATED APPLICATIONS

This document claims priority and contains subject matter related to Japanese Patent Application No. 2000-365659 filed in the Japanese Patent Office on Nov. 30, 2000, and Japanese Patent Application No. 2001-352045 filed in the Japanese Patent Office on Nov. 16, 2001, and the entire contents of each of which are hereby incorporated herein by reference.

### BACKGROUND OF THE INVENTION

1. Field of the Invention

The present invention relates generally to an electrophotographic image forming apparatus, such as, a copying machine, a printer, a facsimile machine, etc. having a powder classifying device. More particularly, the invention relates to a powder classifying device that classifies powder for reuse.

2. Discussion of the Background

An image forming apparatus, such as, a copying machine, a printer, and a facsimile machine, employs an electrophotographic image forming process. In this type of an image forming apparatus, an electrostatic latent image formed on an image bearing member (e.g., a photoreceptor drum) is developed with powder such as toner (hereinafter called toner as a representative example of powder) to form a visible image (e.g., a toner image). A toner image formed on the image bearing member is transferred to a transfer sheet by a transfer device. Subsequently, the transfer sheet having the toner image is conveyed to a fixing device, and the toner image is fixed onto the transfer sheet under the influence of heat and pressure by the fixing device.

Generally, residual toner that is not transferred to the transfer sheet and remains on the surface of the image bearing member is removed by a cleaning device such as a cleaning blade, and is then collected to a used-toner collecting container for disposal.

Recently, from the viewpoint of environmental protection, there is an increasing demand for effective use of resources. In addition, a cost reduction is desired such as extending the useful lifetime of toner. For these reasons, reuse of the collected toner has been demanded. In order to fulfill these demands, the above-described image forming apparatus employing an electrophotographic image forming process has employed a device that collects residual toner on the image bearing member and returns the collected toner to a developing device and a toner replenishing device for recycling.

When toner is recycled in the above-described image forming apparatus, a paper powder (paper dust) and aggregated small toner having a relatively large particle size may be included in collected toner. When the collected toner is returned to a developing device and a toner replenishing device for reuse in subsequent development, deterioration of image quality, such as, a white spot and a black spot, may be caused due to the paper powder and the aggregated small toner included in the collected toner.

In order to remove the above-described paper powder and aggregated small toner from the collected toner, a background image forming apparatus employs a filter device. However, a filter of the filter device typically tends to be clogged with collected toner.

### SUMMARY OF THE INVENTION

According to one aspect of the present invention, a powder classifying device that classifies powder includes a mesh member having meshes, and a brush roller formed with hair-like members and configured to rotate in sliding contact with the mesh member at a predetermined portion in a circumferential direction of the brush roller to push the powder conveyed in a radial direction of the brush roller against the meshes so that the powder is classified into powder passing through the meshes and powder not passing through the meshes.

According to another aspect of the present invention, an image forming apparatus includes an image bearing member configured to bear a latent image, a developing device configured to develop the latent image with powder so as to form a visual image, and a cleaning device configured to remove the powder remaining on the image bearing member. The image forming apparatus further includes a powder classifying device configured to classify the powder removed from the image bearing member by the cleaning device, including a mesh member having meshes, and a brush roller formed with hair-like members and configured to rotate in sliding contact with the mesh member at a predetermined portion in a circumferential direction of the brush roller to push the powder conveyed in a radial direction of the brush roller against the meshes so that the powder is classified into powder passing through the meshes and powder not passing through the meshes. The image forming apparatus further includes a powder conveying device configured to convey the powder passed through the meshes so as to mix with new powder.

Objects, features, and advantages of the present invention will become apparent from the following detailed description when read in conjunction with the accompanying drawings.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic view illustrating a construction of a main part of an image forming apparatus including a toner classifying device according to an embodiment of the present invention;

FIG. 2A is a cross sectional view of the toner classifying device taken in a direction substantially perpendicular to an axial direction of a photoreceptor of the image forming apparatus;

FIG. 2B is a cross sectional view taken along line A-A of FIG. 2A;

FIG. 3 is a schematic perspective view of a brush roller of the toner classifying device according to the embodiment of the present invention;

FIG. 4A is a cross sectional view of the toner classifying device when the brush roller is rotated in a forward direction during classification of toner, and FIG. 4B is a cross sectional view of the toner classifying device when the brush roller is rotated in a reverse direction at a predetermined timing;

FIG. 5A is a diagram illustrating ON/OFF control operations of an image forming apparatus main motor and brush roller drive motor when the brush roller is controlled to be rotated in a reverse direction after completion of image forming job;

FIG. 5B is a diagram illustrating ON/OFF control operations of the image forming apparatus main motor and brush roller drive motor when the brush roller is controlled to be rotated in a reverse direction after a predetermined number of transfer sheets are copied or printed;

FIG. 6 is a block diagram of a control device, the brush roller drive motor, and the brush roller of the image forming apparatus according to the present invention;

FIG. 7 is a cross sectional view of a main part of the toner classifying device taken in a direction substantially perpendicular to the axial direction of the photoreceptor according to another embodiment of the present invention;

FIG. 8 is a cross sectional view of a main part of the toner classifying device and a flicker having an alternative shape;

FIG. 9A is a cross sectional view of a main part of the toner classifying device taken in a direction substantially perpendicular to the axial direction of the photoreceptor;

FIG. 9B is a cross sectional view taken along line B-B of FIG. 9A;

FIG. 10A is a cross sectional view of a main part of the toner classifying device taken in a direction substantially perpendicular to the axial direction of the photoreceptor;

FIG. 10B is a cross sectional view taken along line C-C of FIG. 10A;

FIG. 11A is a cross sectional view of a main part of the toner classifying device taken in a direction substantially perpendicular to the axial direction of the photoreceptor according to an alternative example;

FIG. 11B is a cross sectional view taken along line D-D of FIG. 11A; and

FIG. 12 is a cross sectional view of a toner conveying device according to an alternative example.

### DESCRIPTION OF THE PREFERRED EMBODIMENTS

Preferred embodiments of the present invention are described in detail referring to the drawings, wherein like reference numerals designate identical or corresponding parts throughout the several views.

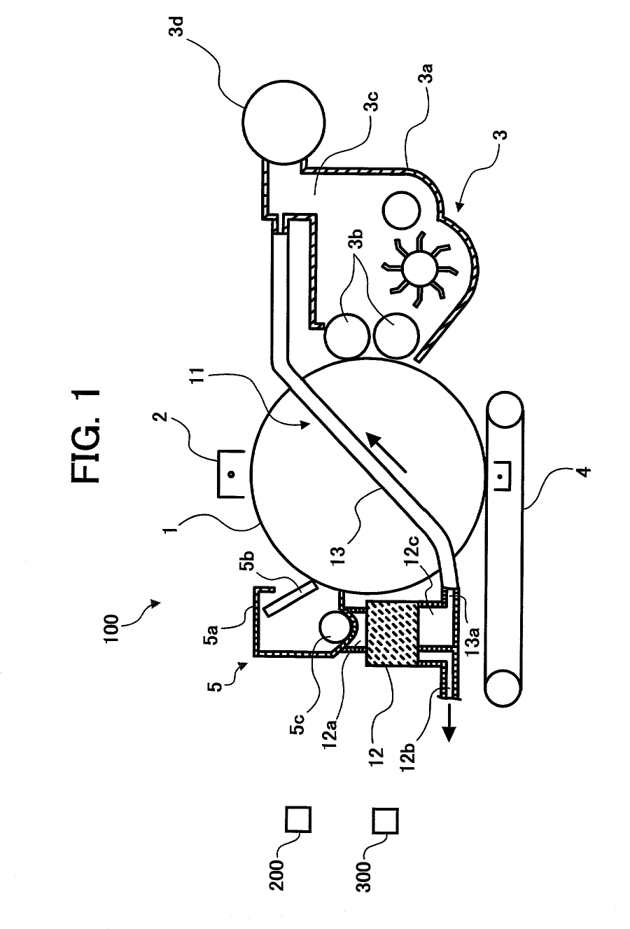

FIG. 1 is a schematic view illustrating a construction of a main part of an image forming apparatus including a toner classifying device according to an embodiment of the present invention.

An image forming apparatus of FIG. 1 includes an image scanning optical system (not shown) that scans an original image, an image writing optical system (not shown) that provides a scanned image with an image forming unit 100 as an image light, and a sheet feeding system (not shown) that feeds a transfer sheet to the image forming unit 100.

The image forming unit 100 of FIG. 1 that performs an electrophotographic image forming process includes a drum-shaped photoreceptor 1 driven to rotate in a direction indicated by an arrow in FIG. 1, a charger 2, a developing device 3, a transfer device 4, and a cleaning device 5.

The photoreceptor 1 serving as an image bearing member is uniformly charged by the charger 2. Subsequently, a latent image is formed on the surface of the photoreceptor 1 by the image writing optical system. The developing device 3 develops the latent image on the photoreceptor 1 with toner so as to form a toner image. The transfer device 4 transfers the toner image from the photoreceptor 1 onto a transfer sheet. After the toner image is transferred from the photoreceptor I to the transfer sheet by the transfer device 4, the cleaning device 5 removes the toner remaining on the photoreceptor 1.

The charger 2, the developing device 3, the transfer device 4, and the cleaning device 5 are arranged around an outer peripheral surface of the photoreceptor 1 in the order of the rotational direction of the photoreceptor 1. A toner recycling device 11, that serves to return the toner removed from the surface of the photoreceptor 1 by the cleaning device 5 to the developing device 3 is provided to the image forming unit 100. The returned toner may be reused in subsequent development.

The developing device 3 includes a casing 3a accommodating a developing roller 3b, and a toner hopper 3c as a toner replenishing part positioned at an upper portion of the casing 3a. The developing device 3 further includes a toner bottle 3d as a new toner container connected to the toner hopper 3c.

The toner recycling device 11 is arranged between the cleaning device 5 and the developing device 3. The toner recycling device 11 includes a toner classifying device 12 connected to the cleaning device 5 so as to classify the toner removed by the cleaning device 5 from the photoreceptor 1, and a toner conveying device 13 that conveys the toner classified by the toner classifying device 12 to the developing device 3.

After image forming operations, the toner removed by the cleaning device 5 is conveyed to the toner classifying device 12 so as to classify the toner into reusable toner and waste toner. Specifically, after an electrophotographic image forming operation is performed in the image forming unit 100, residual toner that is not transferred to a transfer sheet and remains on the surface of the photoreceptor 1 is removed from the surface of the photoreceptor 1 by a cleaning blade 5b in a casing 5a of the cleaning device 5. The toner removed from the surface of the photoreceptor 1 by the cleaning blade 5b is conveyed in a direction perpendicular to the sheet of FIG. 1 by a toner collection coil 5c located at a lower part of the cleaning device 5, and is conveyed into the toner classifying device 12 of the toner recycling device 11. The toner conveyed into the toner classifying device 12 is further conveyed to the toner hopper 3c of the developing device 3 through the tube-shaped toner conveying device 13 so as to be reused for subsequent development. In the tube-shaped toner conveying device 13, a coil or screw (not shown) is provided to convey the classified toner to the developing device 3 by rotating the coil (screw).

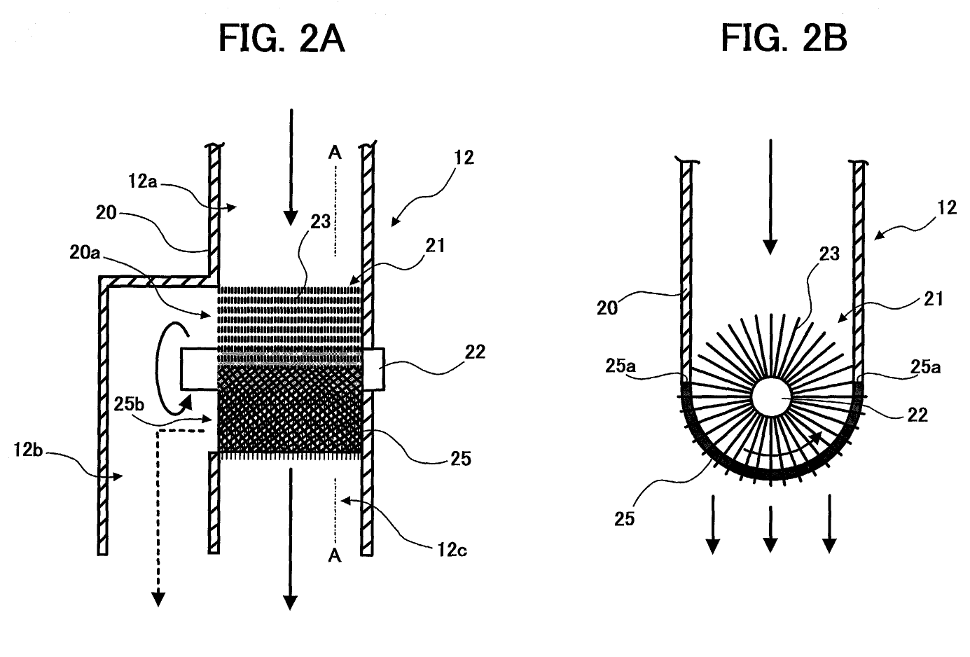

FIG. 2A is a cross sectional view of the toner classifying device 12 taken in a direction substantially perpendicular to an axial direction of the photoreceptor 1. FIG. 2B is a cross sectional view taken along line A-A of FIG. 2A.

As illustrated in FIGS. 2A and 2B, the toner classifying device 12 includes a case 20 and a brush roller 21. The case 20 houses three paths, such as, a removed toner conveying path 12a, a waste toner conveying path 12b, and a recycle toner falling path 12c. The removed toner conveying path 12a and the recycle toner falling path 12c are arranged substantially linearly and vertically. The waste toner conveying path 12b branches off from the linearly extending removed toner conveying path 12a and recycle toner falling path 12c in a direction substantially perpendicular to the removed toner conveying path 12a and recycle toner falling path 12c, and further extends downward in a substantially vertical direction.

The brush roller 21 is arranged such that an axis of the brush roller 21 is substantially parallel to a branch portion 20a of the waste toner conveying path 12b branching off from the removed toner conveying path 12a and the recycle toner falling path 12c in a direction substantially perpendicular to the removed toner conveying path 12a and the recycle toner falling path 12c.

Specifically, the brush roller 21 is arranged such that the brush roller 21 crosses the removed toner conveying path 12a and the recycle toner falling path 12c. Further, both ends of a brush roller shaft 22 of the brush roller 21 are supported by the case 20 such that the brush roller shaft 22 is substantially parallel to the branch portion 20a. The brush roller 21 is driven to rotate by a brush roller drive motor 200 serving as a drive device. The brush roller drive motor 200 is controlled by a motor driver 250.

Moreover, a semicylindrical-shaped mesh member 25 is provided at an opening side of the recycle toner falling path 12c, and is arranged such that surface portions of hair-like members 23 of the brush roller 21 are in sliding contact with the mesh member 25.

As illustrated in FIG. 2A, an end portion of the brush roller 21, at a side of the waste toner conveying path 12b, is exposed toward the waste toner conveying path 12b at the branch portion 20a. Further, the brush roller shaft 22 is provided such that the brush roller shaft 22 crosses over the case 20.

Specifically, the brush roller shaft 22 of the brush roller 21 is provided perpendicularly to a toner conveying direction in the removed toner conveying path 12a. Further, the brush roller 21 at a side of the recycle toner falling path 12c is sliding contact with the mesh member 25, and a one side end portion 25b of the brush roller 21 faces the waste toner conveying path 12b.

With the above-described construction of the toner classifying device 12, the removed toner conveyed from an upper half portion side of the brush roller 21 in a radial direction of the brush roller 21 is separately conveyed from the one side end portion 25b of the brush roller 21 and from a lower half portion side of the brush roller 21 in the radial direction thereof. In this construction of the toner classifying device 12, the removed toner is classified into toner and paper powder passing through the mesh member 25 and toner and paper powder not passing through the mesh member 25.

The mesh member 25 is a sheet-like member, and is attached to the toner classifying device 12 by fixing both end portions 25a of the mesh member 25 substantially parallel to the axial direction of the brush roller 21 to an inner surface of the case 20. Below the mesh member 25, the recycle toner falling path 12c connecting to an inlet 13a of the toner conveying device 13 (illustrated in FIG. 1) continues, and only reusable toner passing through the mesh member 25 falls into the recycle toner falling path 12c.

As one non-limiting example of the mesh member 25, the mesh member 25 includes meshes made of metal wire, and a size of each of the meshes of the mesh member 25 is about 150 mesh according to the embodiment of the present invention. The removed toner conveyed into the toner classifying device 12 may be a particle size which is less than the size of each of the meshes of the mesh member 25 and passes through the mesh member 25 while the brush roller 21 rotates in sliding contact with the mesh member 25.

The brush roller 21 also serves to crush aggregated small toner from the toner removed from the photoreceptor 1 by the cleaning device 5 into small particles. The toner passing through the meshes of the mesh member 25 is returned to the developing device 3 through the toner conveying device 13 for reuse in subsequent development.

The waste toner including paper powder and aggregated small toner not passing through the meshes of the mesh member 25 is discharged from the toner classifying device 12 via the branch portion 20a and the waste toner conveying path 12b by use of vibrations caused by a toner discharging device (not shown). The waste toner discharged from the toner classifying device 12 is conveyed to a used-toner collecting container (not shown) for disposal. The above-described waste toner discharging construction prevents staying and stacking of paper powder and aggregated small toner in the toner classifying device 12.

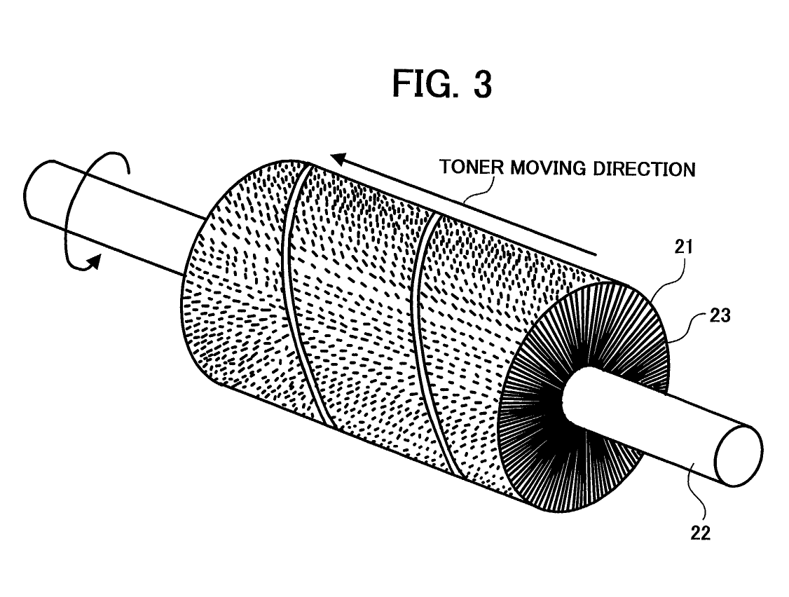

In the toner classifying device 12, as illustrated in FIG. 3, a base of the hair-like members 23 of the brush roller 21 is wound around the brush roller shaft 22 such that paper powder and aggregated small toner in the mesh member 25 is moved toward the branch portion 20a by rotations of the brush roller 21. Specifically, surface portions of the hair-like members 23 of the brush roller 21 are slanted relative to a rotational direction of the brush roller 21 to move paper powder and aggregated small toner not passing through the meshes of the mesh member 25 in the axial direction of the brush roller 21 toward the branch portion 20a. Thereby, the brush roller 21 serves not only to classify toner, but also to discharge paper powder and aggregated small toner from the toner classifying device 12. In this case, it is not necessary that the above-described toner discharging device causes vibrations to the toner classifying device 12. As a result, the construction of the toner classifying device 12 may be simple and at a low cost.

The hair-like members 23 of the brush roller 21 may be made of any materials so long as the hair-like members 23 include a function of guiding and pushing toner removed from the photoreceptor 1 by the cleaning device 5 against the meshes of the mesh member 25. However, when the hair-like members 23 are formed from a conductive material such as an acrylic/carbon fiber, electric failures, such as charging of toner can be prevented when the hair-like members 23 are sliding contact with the mesh member 25 while the brush roller 21 is rotated. In this embodiment, the insulation resistance between the hair-like members 23 of the brush roller 21 and the brush roller shaft 22 is set to a range of about 10¹² ω or less. For example, the insulation resistance in a range of about 10⁸ ω to about 10¹² ω.

Further, each of the hair-like members 23 of the brush roller 21 is substantially straight, and has a thickness smaller than a size of each of the meshes of the mesh member 25. Thereby, tip end portions of the hair-like members 23 of the brush roller 21 may penetrate the meshes of the mesh member 25 when the brush roller 21 pushes toner against the meshes of the mesh member 25. As a result, a failure such as clogging of the meshes of the mesh member 25 with toner may be obviated, so that the toner classifying device 12 may classify toner for a long time.

In this embodiment, a size of each of the meshes of the mesh member 25 is set to a size of a mesh of 150 mesh. Each of the meshes of the mesh member 25 having the size of a mesh of 150 mesh is a quadrilateral of one side about 100 μm. A thickness of each of the hair-like members 23 of the brush roller 21 is set to about 50 μm, and is sufficiently smaller than a size of each of the meshes of the mesh member 25.

Further, because the hair-like members 23 of the brush roller 21 are required to include a function of pushing toner against the meshes of the mesh member 25 as described earlier, the hair-like members 23 need to include rigidity strong enough to penetrate the meshes of the mesh member 25.

The brush roller 21 is rotated in a predetermined direction during the classification of toner. While the brush roller 21 continues to be rotated in a predetermined direction, the hair like members 23 of the brush roller 21 are slanted in the rotational direction of the brush roller 21. As a result, the useful lifetime of the brush roller 21 is shorten, and the toner may not be efficiently classified because a tip end of each of the hair-like members 23 of the brush roller 21 may not penetrate the meshes of the mesh member 25.

In order to solve the above-described failure, the brush roller 21 is controlled to be rotated in a reverse direction by a CPU (central processing unit) 300 through the motor driver 250 at a predetermined timing, such as after completion of image forming job, after a predetermined number of transfer sheets are copied or printed.

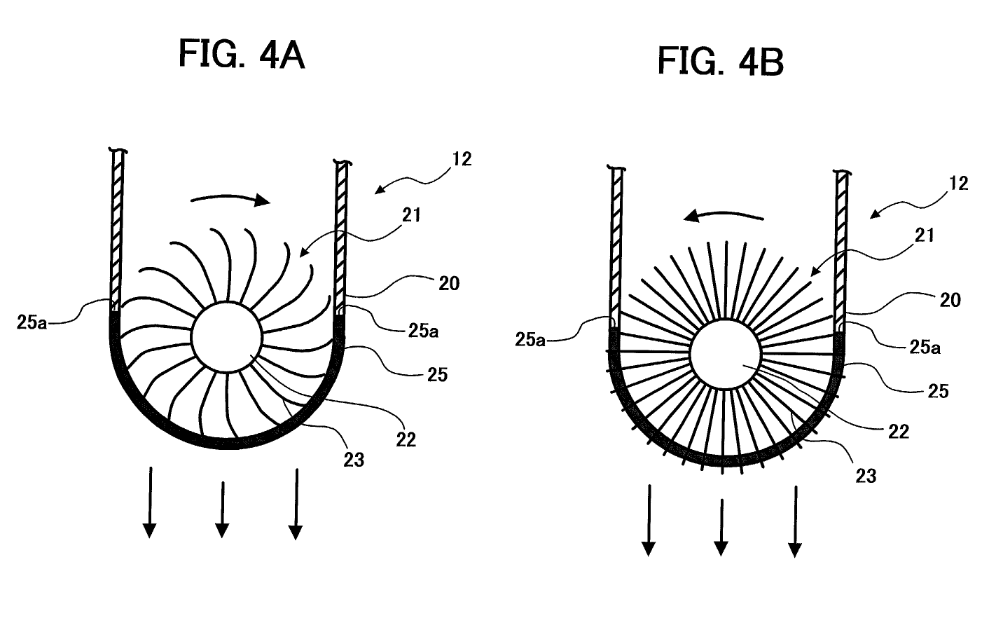

FIG. 4A is a sectional view of the toner classifying device 12 when the brush roller 21 is rotated in a forward direction during classification of toner. FIG. 4B is a sectional view of the toner classifying device 12 when the brush roller 21 is rotated in a reverse direction at a predetermined timing.

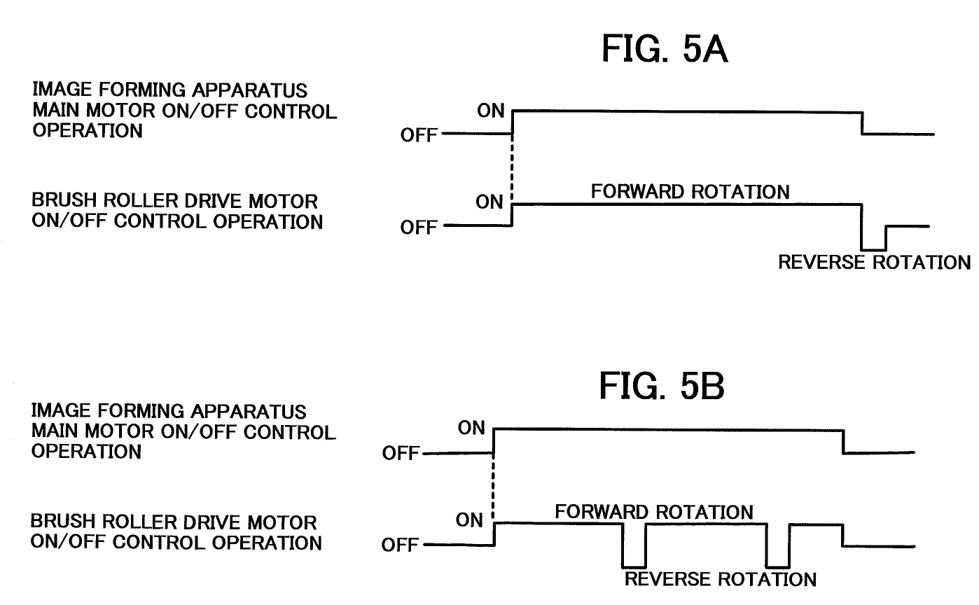

FIG. 5A is a diagram illustrating ON/OFF control operations of an image forming apparatus main motor and brush roller drive motor when the brush roller 21 is controllably rotated in a reverse direction after completion of image forming job.

FIG. 5B is a diagram illustrating ON/OFF control operations of the image forming apparatus main motor and brush roller drive motor when the brush roller 21 is controllably rotated in a reverse direction after a predetermined number of transfer sheets are copied or printed.

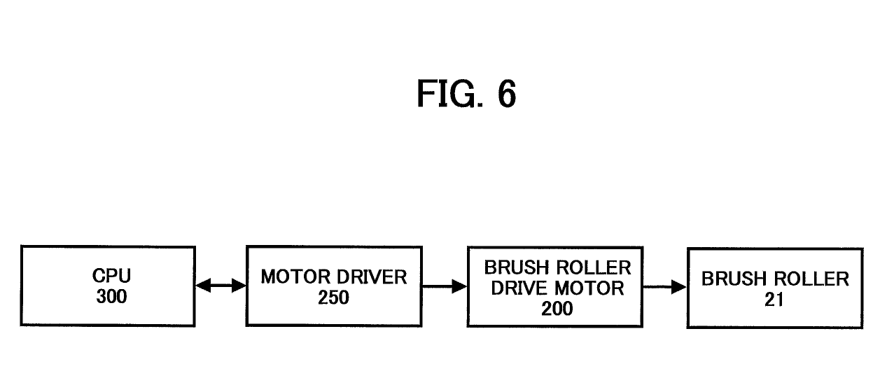

FIG. 6 is a block diagram of a control device, a brush roller drive motor, and a brush roller of the image forming apparatus according to the present invention.

Referring to FIGS. 5A and 6, when the image forming apparatus main motor is turned off (i.e., completion of image forming job), the CPU 300 controls the brush roller drive motor 200 to change rotation in a reverse direction from a forward direction via the motor driver 250, thereby controlling the brush roller 21 to rotate in a reverse direction.

Referring to FIGS. 5B and 6, when a predetermined number of transfer sheets are copied or printed, the CPU 300 controls the brush roller drive motor 200 to change rotation in a reverse direction from a forward direction via the motor driver 250, thereby controlling the brush roller 21 to rotate in a reverse direction.

By controlling the brush roller 21 to rotate in a reverse direction at a predetermined timing, the sliding contact direction of the hair-like members 23 of the brush roller 21 with the mesh member 25 is changed, so that the slanting of the hair-like members 23 of the brush roller 21 caused over the course of time is prevented. Any predetermined timing of controlling the brush roller 21 to rotate in a reverse direction may be set appropriately 10i according to the use condition of the brush roller 21.

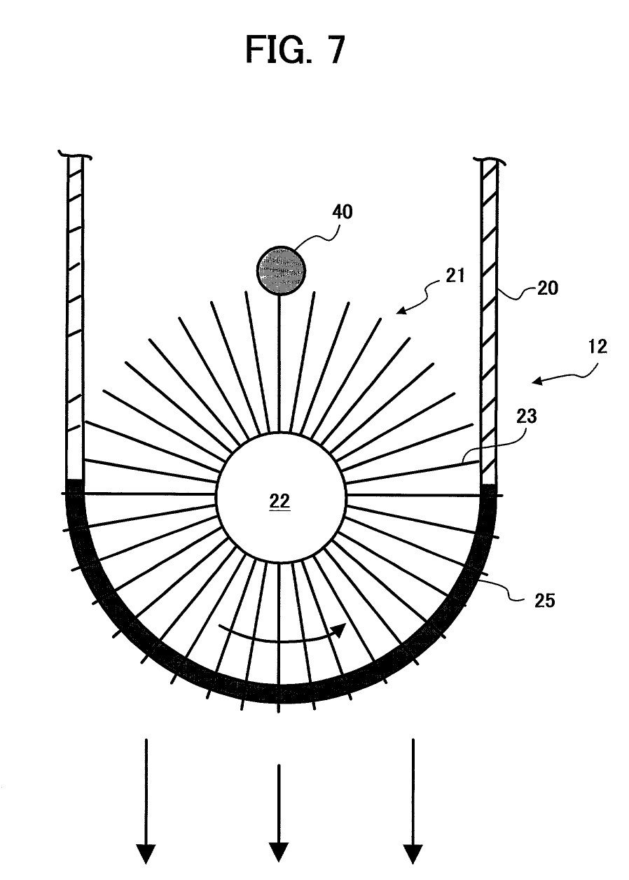

FIG. 7 is a cross sectional view of a main part of the toner classifying device 12 taken in a direction substantially perpendicular to the axial direction of the photoreceptor 1 according to another embodiment of the present. In this embodiment, as illustrated in FIG. 7, a flicker 40 formed from a bar-shaped member such as a stainless bar member is provided in parallel with the brush shaft 22 of the brush roller 21 such that the tip end portions of the hair-like members 23 of the brush roller 21 abut the flicker 40. With the provision of the flicker 40, toner attached onto the hair-like members 23 of the brush roller 21 is much removed. The construction of a toner classifying device of FIG. 7 is substantially the same as that illustrated in FIGS. 2A and 2B with the exception of the flicker 40.

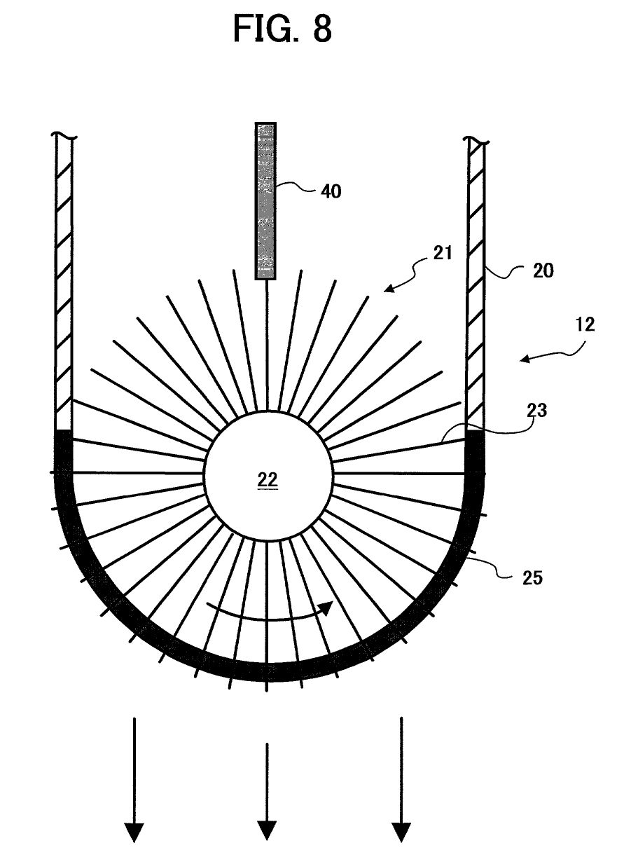

As a non-limiting example of the flicker 40, the flicker 40 may be in a shape of a blade as illustrated in FIG. 8 instead of the bar-shaped flicker 40 illustrated in FIG. 7. The toner is likely to attach onto the hair-like members 23 of the brush roller 21. The hair-like members 23 are elastically deformed by the contact of the flicker 40, and return to an original shape due to their elastic force, thereby causing the toner attached onto the hair-like members 23 to remove therefrom. Owing to the flicker 40, the toner classifying function of the brush roller 21 may be maintained for a relatively long time. When toner I-s attached onto the tip end portions of the hair-like members 23, it is difficult to penetrate the tip end portions of the hair-like members 23 into the meshes of the mesh member 25, thereby suppressing the function of the hair-like members 23 to prevent clogging of the meshes of the mesh member 25 with toner. Therefore, the flicker 40 effectively serves to maintain the toner classifying function of the brush roller 21.

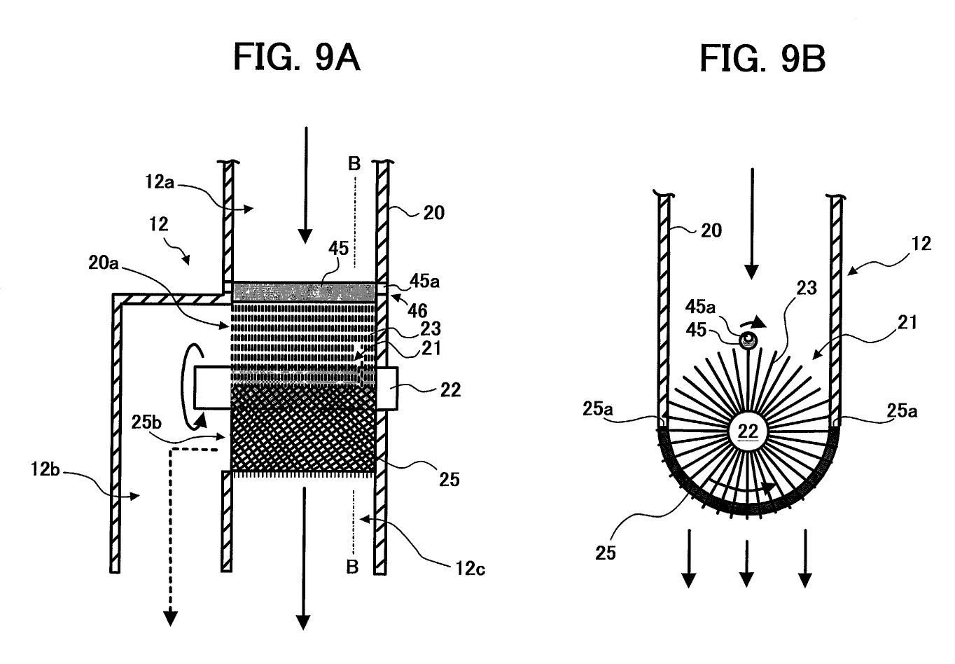

FIG. 9A is a cross sectional view of a main part of the toner classifying device 12 taken in a direction substantially perpendicular to the axial direction of the photoreceptor 1 according to another embodiment of the present invention. FIG. 9B is a cross sectional view taken along line B-B of FIG. 9A.

As an alternative to the flicker 40 illustrated in FIGS. 7 and 8 that is fixedly provided, a flicker 45 is rotatably provided in this another embodiment. Specifically, the flicker 45 formed from a stainless bar or etc. is rotatably supported by a bearing portion 46 about a shaft 45a which is provided in parallel with the brush roller shaft 22 of the brush roller 21. The shaft 45a is an eccentric shaft in this embodiment.

When the flicker 45 is rotated provided, the flicker 45 is rotated by rotating the brush roller 21 in contact with the flicker 45, thereby decreasing the frictional resistance between the flicker 45 and the surface portions of the hair-like members 23 of the brush roller 21. As a result, the useful lifetime of the brush roller 21 may be extended by suppressing the abrasion of the surface portions of the hair-like members 23 of the brush roller 21. The construction of the toner classifying device 12 of FIGS. 9A and 9B are substantially the same as that of the toner classifying device 12 illustrated in FIGS. 2A and 2B with the exception of the flicker 45 and the bearing portion 46.

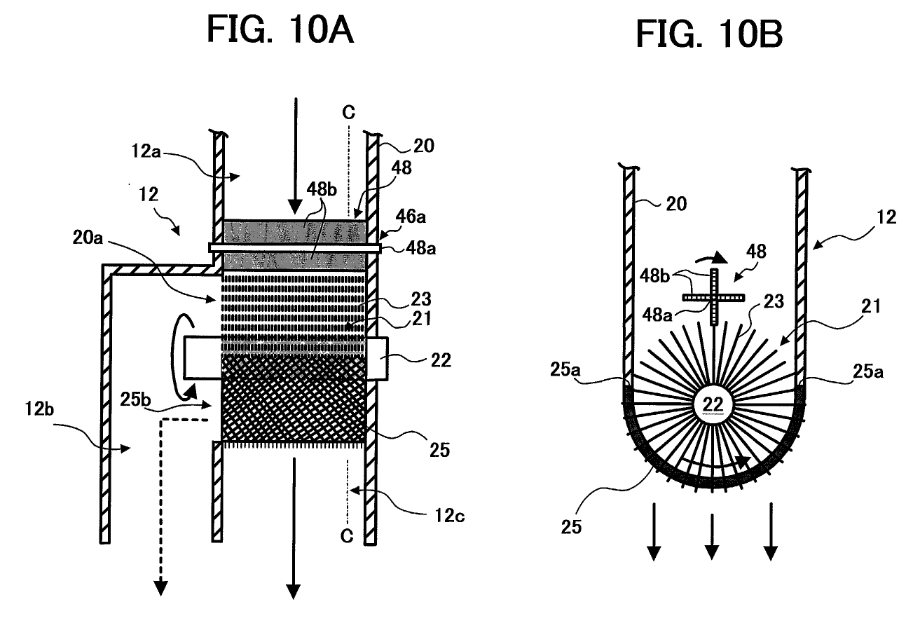

FIG. 10A is a cross sectional view of a main part of the toner classifying device 12 taken in a direction substantially perpendicular to the axial direction of the photoreceptor 1. FIG. 10B is a cross sectional view taken along line C-C of FIG. 10A. As illustrated in FIGS. 10A and 10B, a flicker 48 is formed by combining blade-shaped flickers 40, illustrated in FIG. 8, into a cruciform cross section. The flicker 48 is constructed so that a shaft 48a of the flicker 48 arranged in parallel with the brush shaft 22 is rotatably supported by a bearing portion 46a, and the flicker 48 is rotated by rotating the brush roller 21 in contact with the flicker 48. According to this another embodiment of the present invention, a plurality of blade plates 48b of the flicker 48 contact the surface portions of the hair-like members 23 of the brush roller 21 when rotating the brush roller 21. Therefore, the ability of removing toner from the surface portions of the hair-like members 23 of the brush roller 21 is higher than that of the flicker 45 of FIGS. 9A and 9B. The construction of the toner classifying device 12 of FIGS. 10A and 10B are substantially the same as that of the toner classifying device 12 illustrated in FIGS. 2A and 2B, with the exception of the flicker 48 and the bearing portion 46a.

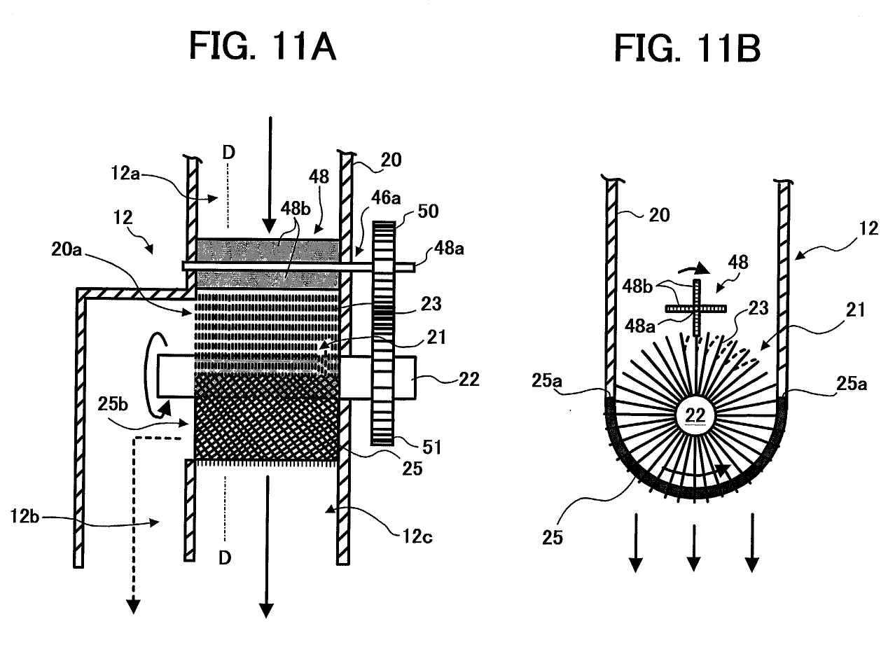

FIGS. 11A and 11B illustrate an alternative example of the toner classifying device 12 of FIGS. 10A and 10B. FIG. 11A is a cross sectional view of a main part of the toner classifying device 12 taken in a direction substantially perpendicular to the axial direction of the photoreceptor 1 according to an alternative example. FIG. 11B is a cross sectional view taken along line D-D of FIG. 11A. In this alternative example, the flicker 48 is constructed so that the flicker 48 is rotated at a different circumferential velocity from that of the brush roller 21. As illustrated in FIG. 11A, a gear 50 is provided to one side of the shaft 48a of the flicker 48, and a gear 51 is provided to one side of the brush roller shaft 22 of the brush roller 21. The gears 50 and 51 having different diameters engage with each other. In this construction, when rotating the brush roller 21 by the brush roller drive motor 200, the flicker 48 is driven to rotate via the gears 51 and 50. Thereby, the flicker 48 and the brush roller 21 are rotated at different circumferential velocities. Specifically, the circumferential velocity of the flicker 48 is faster than that of the brush roller 21.

By rotating the flicker 48 and the brush roller 21 at different circumferential velocities, as described above, the hair-like members 23 of the brush roller 21 are whisked in a direction opposite to their slanting direction by the flicker 48, so that the slanting of the hair-like members 23 can be corrected.

Further, by changing the difference of the circumferential velocities between the brush roller 21 and the flicker 48, the relation between the ability of the flicker 48 to remove toner attached onto the brush roller 21 and the slanting of the hair-like members 23 of the brush roller 21 may be adjusted adequately.

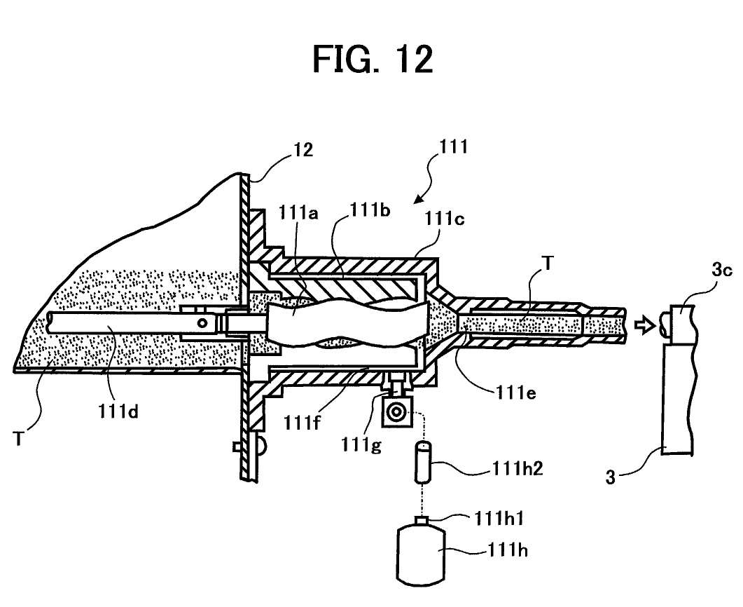

Next, an alternative example of the toner conveying device 13 of the toner recycling device 11 illustrated in FIG. 1 will be described. FIG. 12 is a cross sectional view of a toner conveying device according to an alternative example. In this example, a toner conveying device 13a includes an air pump instead of the coil (screw). In the toner conveying device 13 of FIG. 1, reusable toner is conveyed to the developing device 3 by rotations of the coils provided in the toner conveying device 13. In the toner conveying device 13a of FIG. 12, toner classified in the toner classifying device 12 is conveyed to the developing device 3 by an air pump and a flexible pipe. Specifically, reusable toner T is conveyed to the developing device 3 by a pump unit 111. A toner conveying path of the toner conveying device 13 is preferably formed from a material having flexibility and toner-resisting property such as nylon, Teflon (trade mark), etc.

When conveying toner by use of the coil (screw), property of toner may be changed due to the friction between the toner and the coil (screw). On the other hand, when conveying toner by use of the pump unit 111, the change of the property of toner is typically suppressed.

The pump unit 111 employs a screw pump of so-called moineau pump and includes a rotor 111a, a stator 111b, and a holder 111c. The rotor 111a is engaged with a drive motor (not shown) as a driving source via a drive shaft of a toner conveying screw 111d, and is driven to rotate by rotating the drive motor. Specifically, the powder pump unit 111 includes the rotor 111a connected to the drive motor via the drive shaft of the toner conveying screw 111d, the stator 111b formed from an elastic body such as rubber material and fixed surrounding the rotor 111a, and the holder 111c holding the stator 111b. In the toner conveying device 13a, classified toner at a lower portion of the toner classifying device 12 is taken in by the toner conveying screw 111d, and is conveyed to a toner conveying path 111e by rotating the rotor 111a.

A gap 111f of, for example, about 1 mm is formed between a side surface of the stator 111b and an inner side surface of the holder 111c, and communicates with the toner conveying path 111e. The pump unit 111 further includes a gas pump 111h, a gas supply tube 111h2, and a gas supply opening 111g.

The gas supply opening 111g communicates with the toner conveying path 111e, and communicates with the gas pump 111h through the gas supply tube 111h2 and a gas discharge opening 111h1 provided with the gas pump 111h.

When the gas pump 111h is actuated, air is injected into toner T in the toner conveying path 111e through the gas supply tube 111h2, the gas supply opening 111g, and the gap 111f, at an air blasting amount of about 0.5-1.0 liters/minute, for example. With the above-described construction of the pump unit 111, the fluidity of the toner T in the toner conveying path 111e is enhanced. The toner T mixed with air is discharged from the toner conveying path 111e to the toner hopper 3c of the developing device 3 so as to be reused for subsequent development.

According to the embodiments of the present invention, the toner classifying device 12 classifies toner with simple construction for reuse. In the toner classifying device 12, paper powder and aggregated small toner may be removed from the toner removed from the photoreceptor 1 by the cleaning device 5 without causing the meshes of the mesh member 25 to be clogged.

Further, in the image forming apparatus according to the embodiments of the present invention, effective use of resources may be achieved by recycling toner, and occurrence of deterioration of image can be suppressed.

The present invention has been described with respect to the embodiments illustrated in figure. However, the present invention is not limited to the embodiments and may be practiced otherwise.

For example, the above-described toner recycling device 11 including the toner classifying device 12 and the toner conveying device 13 may be employed in an electrophotographic image forming process cartridge wherein a photoreceptor, a developing device, a cleaning device, etc. are integrally accommodated in a case.

Further, in the above-described embodiments of the present invention, the toner classified in the toner classifying device 12 is conveyed to the developing device 3. Alternatively, it can be configured that the toner classified in the toner classifying device 12 is replenished to a toner bank including a plurality of toner bottles so as to mix with new toner. Subsequently, the recycled toner mixed with new toner is supplied to the developing device 3 from the toner bank.

The present invention can be applied to any image forming apparatuses such as a copying machine, a printer, and a facsimile machine. Numerous additional modifications and variations of the present invention are possible in light of the above teachings. It is therefore to be understood that within the scope of the appended claims, the present invention may be practiced otherwise than as specifically described herein.

What is claimed as new and is desired to be secured by Letters Patent of the United States is:

1. A powder classifying device that classifies powder, comprising:
a mesh member including meshes; and
a brush roller formed with hair-like members and configured to rotate in sliding contact with the mesh member at a predetermined portion in a circumferential direction of the brush roller to push the powder conveyed in a radial direction of the brush roller against the meshes so that the powder is classified into powder passing through the meshes and powder not passing through the meshes.

2. The powder classifying device according to claim 1, further comprising a powder conveying device configured to convey the powder passed through the meshes.

3. The powder classifying device according to claim 1, wherein the brush roller is further configured to move the powder not passing through the meshes, in an axial direction of the brush roller.

4. The powder classifying device according to claim 3, wherein surface portions of the hair-like members of the brush roller are slanted in the axial direction of the brush roller in which the powder not passing through the meshes is moved relative to a rotational direction of the brush roller.

5. The powder classifying device according to claim 1, wherein the hair-like members of the brush roller have conductivity.

6. The powder classifying device according to claim 1, wherein each of the hair-like members of the brush roller is substantially straight, and has a thickness smaller than a size of each of the meshes of the mesh member.

7. The powder classifying device according to claim 1, further comprising:
a drive device configured to drive the brush roller to rotate; and
a control device configured to control the brush roller to rotate in forward and reverse directions.

8. The powder classifying device according to claim 1, further comprising a contact member configured to contact the hair-like members of the brush roller.

9. The powder classifying device according to claim 8, further comprising a supporting member configured to rotatably support the contact member.

10. The powder classifying device according to claim 8, further comprising a device configured to rotate the brush roller and the contact member at different circumferential velocities.

11. The powder classifying device according to claim 1, wherein the powder is toner.

12. An image forming apparatus, comprising:
an image bearing member configured to bear a latent image;
a developing device configured to develop the latent image with powder so as to form a visual image;
a cleaning device configured to remove the powder remaining on the image bearing member;
a powder classifying device configured to classify the powder removed from the image bearing member by the cleaning device, including,
a mesh member including meshes; and
a brush roller formed with hair-like members and configured to rotate in sliding contact with the mesh member at a predetermined portion in a circumferential direction of the brush roller to push the powder conveyed in a radial direction of the brush roller against the meshes so that the powder is classified into powder passing through the meshes and powder not passing through the meshes; and
a powder conveying device configured to convey the powder passed through the meshes so as to mix with new powder.

13. The image forming apparatus according to claim 12, wherein the brush roller is further configured to move the powder not passing through the meshes, in an axial direction of the brush roller.

14. The image forming apparatus according to claim 13, further comprising a powder conveying path configured to dispose of the powder not passing through the meshes and moved in the axial direction of the brush roller.

15. The image forming apparatus according to claim 13, wherein surface portions of the hair-like members of the brush roller are slanted in the axial direction of the brush roller in which the powder not passing through the meshes is moved relative to a rotational direction of the brush roller.

16. The image forming apparatus according to claim 12, wherein the hair-like members of the brush roller have conductivity.

17. The image forming apparatus according to claim 12, wherein each of the hair like members of the brush roller is substantially straight and is a thickness smaller than a size of each of the meshes of the mesh member.

18. The image forming apparatus according to claim 12, further comprising:
a drive device configured to drive the brush roller to rotate; and
a control device configured to control the brush roller to rotate in forward and reverse directions.

19. The image forming apparatus according to claim 12, further comprising a contact member configured to contact the hair-like members of the brush roller.

20. The image forming apparatus according to claim 19, further comprising a supporting member configured to rotatably support the contact member.

21. The image forming apparatus according to claim 19, further comprising a device configured to rotate the brush roller and the contact member at different circumferential velocities.

22. The image forming apparatus according to claim 12, wherein the powder is toner removed from the image bearing member.

23. An image forming apparatus, comprising:
means for bearing a latent image;
means for developing the latent image with powder so as to form a visual image;
means for removing the powder remaining on the means for bearing;
means for classifying the powder removed from the means for bearing by the means for removing, including,
a mesh member including meshes; and
means for rotating in sliding contact with the mesh member at a predetermined portion in a circumferential direction of the means for rotating to push the powder conveyed in a radial direction of the means for rotating against the meshes so that the powder is classified into powder passing through the meshes and powder not passing through the meshes, the means for rotating being formed with hair-like members; and
means for conveying the powder passed through the meshes so as to be mixed with new powder.

24. The image forming apparatus according to claim 23, further comprising:
means for driving the means for rotating to rotate; and
means for controlling the means for rotating to rotate in forward and reverse directions.

25. The image forming apparatus according to claim 23, further comprising means for contacting the hair-like members of the means for rotating.

26. The image forming apparatus according to claim 25, further comprising means for rotatably supporting the means for contacting.

27. The image forming apparatus according to claim 25, further comprising means for variably rotating the means for rotating and the means for contacting at different circumferential velocities.

28. A method of classifying powder, comprising the steps of:
conveying powder to a brush roller in a radial direction of the brush roller;
rotating the brush roller in sliding contact with meshes of a mesh member; and
pushing the powder against the meshes of the mesh member.

29. The method according to claim 28 further comprising the step of moving the powder not passing through the meshes in an axial direction of the brush roller.

30. The method according to claim 28, wherein the step of rotating the brush roller comprises controlling the brush roller to rotate in forward and reverse directions.
